(19) United States
(12) Patent Application Publication
(10) Pub. No.: US 2024/0126813 A1
(43) Pub. Date: Apr. 18, 2024

(54) Global Data Management Framework

(71) Applicant: Live Oak Banking Company, Wilmington, NC (US)

(72) Inventors: Bryan Curtis Friend, Alma, MI (US); Kyle Errol Gower-Winter, Cary, NC (US); Piriya Saengsuwarn, Wilmington, NC (US)

(21) Appl. No.: 18/488,524

(22) Filed: Oct. 17, 2023

Related U.S. Application Data
(60) Provisional application No. 63/505,716, filed on Jun. 2, 2023.
(60) Provisional application No. 63/416,703, filed on Oct. 17, 2022.

(51) Int. Cl. G06F 16/901; G06F 16/9038

(52) U.S. Cl. CPC G06F 16/9024; G06F 16/9038

(57) ABSTRACT

Example implementations provide an example computer-implemented method. The example method can include obtaining state data associated with a client session and a first data object; receiving a request to provide a viewport for interaction with one or more second data objects related to the first data object; initiating a global graph search to identify the one or more second data objects, the global graph search performed using a plurality of local data managers to respectively search a plurality of local data tables; configuring an interactive graph structure based on the state data and the global graph search; and outputting the interactive graph structure configured for rendering within the viewport; wherein the interactive graph structure is configured to facilitate interaction with the one or more second data objects within the viewport.

### PRIORITY

This application claims priority to U.S. Provisional Patent Application No. 63/505,716, filed Jun. 2, 2023. U.S. Provisional Patent Application No. 63/505,716 is hereby incorporated by reference herein in its entirety. This application also claims priority to U.S. Provisional Patent Application No. 63/416,703, filed Oct. 17, 2022. U.S. Provisional Patent Application No. 63/416,703 is hereby incorporated by reference herein in its entirety.

### BACKGROUND

Data records and documents can be stored by various systems. In some situations, different data can be stored in different data tables. In some circumstances, different data managers can manage storage in the different data tables.

### SUMMARY

The present disclosure is directed to a global data management framework that can provide a unified interface for interacting with data stored and managed using multiple different local data managers. The global data management framework can receive queries for data that spans multiple different local data managers, automatically query the local data managers, and compile results from the different data managers. In this manner, for example, example implementations of the global data management framework can streamline the processes of data retrieval and update across diverse data storage configurations.

The global data management framework can include a global viewport. The global viewport can provide a unified interface for interacting with data objects. In some circumstances, different data objects can be stored using different data managers (e.g., for different storage locations, different storage mediums, different data types, etc.). Advantageously, the global viewport can provide an interface for querying over multiple different data managers and viewing and engaging with the results.

The global data management framework can return results in a structured format for display in the global viewport. For instance, the global data management framework can return results in an interactive graph structure that charts the returned data objects and their relationships. In this manner, for example, the global viewport can present a unified map of interrelated data objects that were retrieved from multiple different data managers.

Some prior approaches use different data managers for different sets of data without any available mechanism for retrieving results to a global query that spans the different sets of data. Such prior approaches can lead to inefficiencies in accessing and updating data, generally requiring individual and independent engagement with each data manager to execute a respective portion of a query.

Some prior approaches to global queries do not use different data management whatsoever and simply maintain a single global data table for all data, no matter the classification or type. Such approaches can lead to other inefficiencies and challenges when managing access control, permissions, etc. across different data types.

Advantageously, example implementations of the global data management framework can leverage the strengths of existing local data management systems while unlocking new freedom to interact with the stored data through a unified, streamlined process flow. For instance, the global data management framework can be configured to handle all interactions with the local data managers. For instance, the global data management framework can receive a high-level, global query (e.g., “return documents related to X”) and generate individual queries for the respective local data managers using respective communication protocols and interfaces, which may be the same or different across the different data managers.

The global data management framework can also advantageously generate relational data structures that map interrelated data objects across different local data managers. In this manner, example implementations can preserve rich contextual data that may otherwise be lost under traditional, segregated data management schemes.

Example implementations of the global data management framework can provide for a number of technical effects and benefits. For instance, by providing a unified viewport for accessing and updating data objects distributed across local data managers, example implementations can reduce the computing resources (e.g., electrical resources, memory resources, processing bandwidth, etc.) required to access and update those data objects, especially as compared to prior techniques that required users to manually and independently access and update data via each data manager.

Furthermore, by providing a unified viewport for accessing and updating data objects distributed across local data managers, example implementations can decouple an underlying system of data managers from a user-facing global viewport. In this manner, for example, a unified global viewport can remain stable even while one or more local data managers are updated, moved, reconfigured, etc. This can increase system uptime, decrease user error, isolate debugging efforts, etc.

For example, in an aspect, the present disclosure provides an example method. The example method includes obtaining state data associated with a client session and a first data object. The example method includes receiving a request to provide a viewport for interaction with one or more second data objects related to the first data object. The example method includes initiating a global graph search to identify the one or more second data objects, the global graph search performed using a plurality of local data managers to respectively search a plurality of local data tables. The example method includes configuring an interactive graph structure based on the state data and the global graph search. The example method includes outputting the interactive graph structure configured for rendering within the viewport. In the example method, the interactive graph structure is configured to facilitate interaction with the one or more second data objects within the viewport.

In some implementations of the example method, the example method includes relaying at least one data object from a first local data manager to a second local data manager, initiating a functionality of the second local data manager that is absent from the first local data manager, and relaying the at least one data object from the second local data manager to the first local data manager.

In some implementations of the example method, at least one of the one or more second data objects is at least one of: a document, a data record, or a placeholder.

In some implementations of the example method, the state data indicates a task view, and wherein the interactive graph structure is configured by sorting the one or more second data objects according to a schema associated with the task view.

In some implementations of the example method, the schema indicates a data object type for the root of the interactive graph structure.

In some implementations of the example method, the schema indicates an initial position for interaction within the interactive graph structure.

In some implementations of the example method, the initial position corresponds to an initial state of the viewport.

In some implementations of the example method, the state data indicates a user account, and wherein the viewport is configured based on user configuration data associated with the user account.

In some implementations of the example method, the state data indicates temporary configuration parameters persisted in a temporary cache on a client computing device.

In some implementations of the example method, the interactive graph structure is configured with selectable input elements that trigger display of at least one of the one or more second data objects within the viewport.

In some implementations of the example method, the interactive graph structure is rendered within the viewport in a tree structure.

In some implementations of the example method, the interactive graph structure visually represents one or more relationships between the first data object and the one or more second data objects.

In some implementations of the example method, the viewport is configured to facilitate editing, within the viewport, of at least one of the one or more second data objects.

In some implementations, the example method includes receiving, from the viewport, an edit to at least one of the one or more second data objects. In some implementations, the example method includes instructing the respective local data manager corresponding to the at least one of the one or more second data objects to update the at least one of the one or more second data objects in the corresponding data table.

In some implementations of the example method, the viewport is rendered within a graphical user interface.

In some implementations of the example method, the viewport is rendered on a display device of a client computing system.

In some implementations of the example method, the viewport is implemented in a web browser.

In some implementations of the example method, the request is based on an input signal received at a client computing device.

In some implementations of the example method, the request is triggered by execution of a hyperlink at a client computing device.

In some implementations of the example method, the request is triggered by a refresh command executed at a client computing device.

In some implementations of the example method, the global graph search is dynamically performed responsive to receiving the request.

In some implementations of the example method, the global graph search is performed by, for a respective local data manager of the plurality of local data managers, obtaining a respective query for the respective local data manager based on an aspect of the first data object and obtaining, from the respective local data manager and responsive to the respective query, respective query results.

In some implementations of the example method, a subsequent respective query for a subsequent respective local data manager is based on prior respective query results.

In some implementations of the example method, the global graph search is a depth-first search.

In some implementations of the example method, the global graph search is a breadth-first search across the plurality of local data managers and a depth-first search within each local data manager.

In some implementations of the example method, the plurality of local data managers share at least a portion of a data store.

In some implementations of the example method, a first local data manager of the plurality of local data managers manages a first data table in a first data store; and a second local data manager of the plurality of local data managers manages a second data table in a second data store.

In some implementations of the example method, the first data store is hosted by a first entity and the second data store is hosted by a second entity.

In some implementations of the example method, results of the global graph search form a knowledge graph associated with the first data object.

In some implementations of the example method, the interactive graph structure implicitly encodes semantic relationships between the one or more second data objects and the first data object.

For example, in an aspect, the present disclosure provides for one or more example non-transitory computer-readable media storing instructions that are executable to cause one or more processors to perform operations. In some implementations, the operations include implementations of the example method.

For example, in an aspect, the present disclosure provides an example computing system including the one or more example non-transitory computer-readable media.

Other example aspects of the present disclosure are directed to other systems, methods, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 is a block diagram of an example global data management framework according to the present disclosure;

FIG. 2 is a block diagram of aspects of an example global data management framework according to the present disclosure;

FIG. 3A is a block diagram of aspects of an example global data management framework according to the present disclosure;

FIG. 3B is an illustration of an example global viewport according to the present disclosure;

FIG. 3C is an illustration of an example global viewport according to the present disclosure;

FIG. 3D is an illustration of an example global viewport according to the present disclosure;

FIG. 3E is an illustration of an example global viewport according to the present disclosure;

FIG. 4 is a flowchart of an example method according to some implementations of the present disclosure; and

FIG. 5 is a block diagram of an example computing system for performing according to some implementations of the present disclosure.

### DETAILED DESCRIPTION

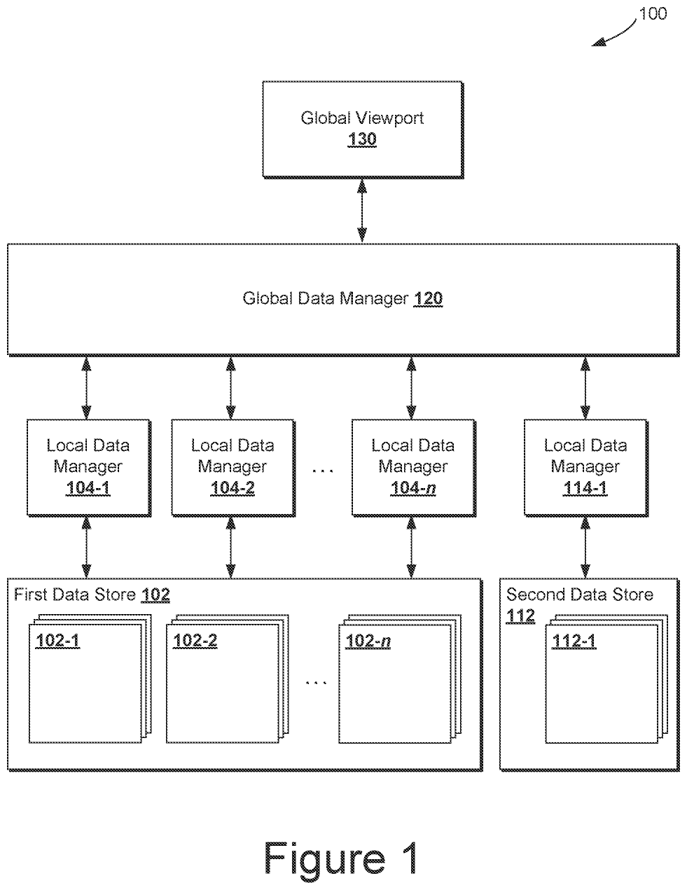

With reference to FIGS. 1-5, example implementations of the present disclosure are discussed in further detail.

FIG. 1 is a block diagram of an example global data management framework 100 according to the present disclosure. A first data store 102 can store data objects in a number of different data tables (or sets thereof) 102-1, 102-2, . . . 102-n. Local data managers 104-1, 104-2, . . . , 104-n can respectively manage respective data tables 102-1, 102-2, . . . , 102-n. Other data stores can be used, such as second data store 112 with data table 112-1 managed by local data manager 114-1. A global data manager 120 can interact with any or all of the local data managers 104-1, 104-2, . . . , 104-n and 114-1. The global data manager 120 can pass data from the various local data managers to the global viewport 130 to present a unified, streamlined interface.

First data store 102 or second data store 112 can include one or more storage locations for storing data. First data store 102 or second data store 112 can be implemented on bare metal or virtualized. First data store 102 or second data store 112 can be hosted on one device or system or on a plurality of devices or systems (e.g., in a distributed manner). First data store 102 and second data store 112 can be hosted by the same or different entities. First data store 102 and second data store 112 can implement the same or different file format(s) or communication(s) protocols.

Data tables (e.g., data tables 102-1, 102-2, . . . , 102-n, or 112-1, etc.) can include one or more portions of a database. For example, data tables 102-1 can include one or more data tables containing data. Data tables 102-2, 102-n, 112-1 can also include one or more data tables containing data. The different data tables can be part of the same or different databases. The different data tables can be configured

Data objects can include data elements indexed and stored in one or more data tables or other portions of a data store. For instance, database entries or portions thereof can be data objects. Data objects can include or otherwise represent documents. For instance, imaged documents can be stored as a data object. Documents can also be transcribed (e.g., automatically, manually) such that the contents of the document(s) are parsed and natively stored as one or more data elements.

Data objects can store references to other data objects. Related data objects can be stored together (e.g., in the same data table(s)) or separately (e.g., in different data table(s)). Data objects can also be related by one or more shared characteristics. For instance, data objects can share one or more identifiers that indicates a relationship.

Data managers 104-1, 104-2, . . . , 104-n, or 114-1 can directly interface with the corresponding data tables 102-1, 102-2, . . . , 102-n, or 112-1 to input, retrieve, and organize the data objects stored therein. Data managers 104-1, 104-2, . . . , 104-n, or 114-1 can implement one or more application programming interfaces (APIs) or other communication protocols for facilitating data input/retrieval in the respective data tables 102-1, 102-2, . . . , 102-n, or 112-1. Data managers 104-1, 104-2, . . . , 104-n, or 114-1 can maintain a set of rules or permissions restricting or otherwise controlling data input/retrieval in the respective data tables 102-1, 102-2, . . . , 102-n, or 112-1.

Global data manager 120 can receive a request to obtain one or more data objects for presentation in the global viewport 130. For instance, the request can be based on a query entered into an input field. The request can be based on a contextual cue detected by the global data manager 120. The request can be based on a context in which the global data manager 120 is launched (e.g., the content of a landing page from which the global data manager 120 is launched). For instance, the request can include a query for data objects related to an object indicated in the request.

Based on the request, global data manager 120 can communicate with any of data managers 104-1, 104-2, . . . , 104-n, or 114-1 to initiate data input/retrieval in the respective data tables 102-1, 102-2, . . . , 102-n, or 112-1. For instance, global data manager 120 can be configured with to maintain instructions (e.g., compatible data formats, etc.) or credentials for communication with any of data managers 104-1, 104-2, . . . , 104-n, or 114-1. Global data manager 120 can operate as a relay to shift data objects from one local data manager to another (e.g., temporarily, such as for a particular task).

Global data manager 120 can be implemented on the same or a different computing system as any of data managers 104-1, 104-2, . . . , 104-n, or 114-1. Global data manager 120 can be operated by a first entity and any of data managers 104-1, 104-2, . . . , 104-n, or 114-1 can be operated by a second entity.

For instance, any of data managers 104-1, 104-2, . . . , 104-n, or 114-1 (along with the corresponding data table(s) and data store(s)) can operate as a service (e.g., software as a service) provided by a service provider entity. Global data manager 120 can operate as a layer on top of the service.

Global viewport 130 can be a user interface for engaging the functionality of the global data manager. The global viewport 130 can be a web-based interface configured to operate in a browser. The global viewport 130 can be a native application for execution within an operating system of a computing device. The global viewport 130 can be configured to present data retrieved by the global data manager 120 in a single pane or view.

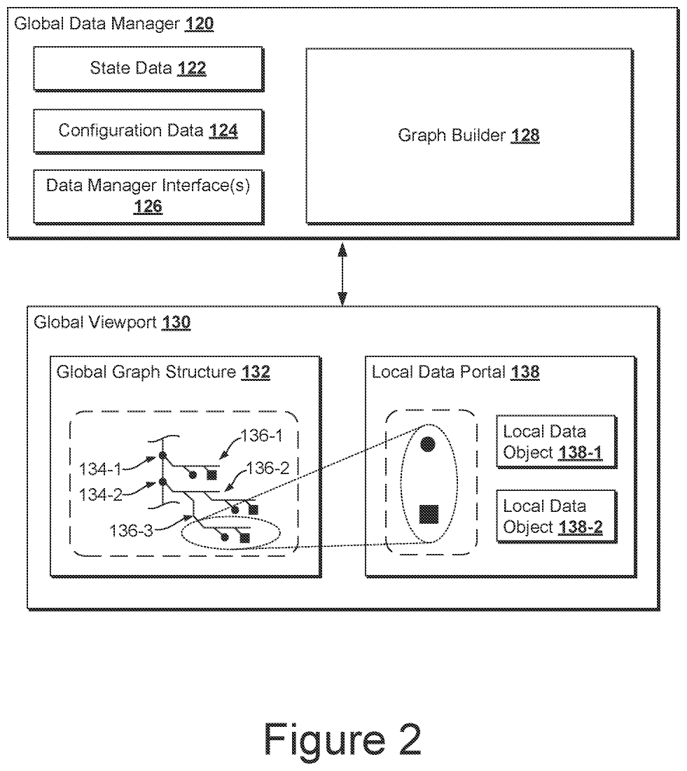

FIG. 2 is a block diagram illustrating aspects of example implementations of global data manager 120 and global viewport 130. For instance, global data manager 120 can use state data 122 to adapt its operation to the state of the system accessing the global data manager 120. Global data manager 120 can use configuration data 124 to adapt its operation according to custom parameters or other configuration preferences. Global data manager 120 can leverage data manager interface(s) 126 to communicate with the local data managers. Graph builder 128 can process the data retrieved from the data store(s) to generate a structured arrangement for presentation in the global viewport 130. For instance, global viewport 130 can display a global graph structure 132 (e.g., obtained using graph builder 128). For instance, global graph structure 132 can include an organized presentation of a number of results, including data objects 134-1 and 134-2. Each of the results can be associated with groups of nested objects 136-1, 136-2, and 136-3. The global graph structure 132 can be interactive. For instance, interactions with nested object group 136-3 (e.g., click, tap) can launch, in local data portal 138, an interface for interacting with local data object 138-1 and local data object 138-2.

State data 122 can include data descriptive of a session of interaction with the global data manager 120. The state data 122 can indicate a user account associated with the session. For instance, a session can include a journey through a software platform that implements the global data manager 120. For instance, state data 122 can include data descriptive of the context from which the global data manager 120 was launched. For instance, the state data 122 can include indications of what data objects were being explored by the system when the global data manager 120 was launched.

For example, state data 122 can include data indicative of a first data object. Global data manager 120 can be launched from a session state associated with the first data object (e.g., from a landing page associated with the first data object). In this manner, for instance, the global data manager 120 can process a request to search for other data objects related to the first data object (e.g., using the data manager interface(s) 126).

Configuration data 124 can include instructions or other parameters for configuring the global data manager 120 or the global viewport 130. Configuration data 124 can be associated with a user account (e.g., as indicated in the state data 122). The configuration data 124 can include temporary configuration parameters. For instance, the temporary configuration parameters can be persisted temporarily in a cache of a client computing device used to access the global data manager 120. In this manner, for example, the temporary configuration parameters can be quickly reset by, for instance, refreshing a web browser used to implement the global viewport 130.

Configuration data 124 can include configuration schemas associated with one or more task views. For instance, a task view can be associated with a context in which the global data manager 120 is being invoked. For instance, a task view can be associated with a particular task of a user invoking the global data manager 120. For a given task, the global data manager 120 can be specially configured as desired for that task, and the configuration can automatically adjust for a different task. The task view can be associated with a schema that specifies an initial state of the global viewport 130. For instance, the initial state can indicate an initial position within the global graph structure for display in the local data portal 138 (e.g., an initial object or group to initialize as selected). State data 122 can trigger different task views based on the contextual information associated with the invocation of global data manager 120.

The graph builder 128 can generate a graph structure based on the request. For instance, data object 134-1 can be a first data object indicated in a request. The global data manager 120 can search across a plurality of local data managers via data manager interface(s) 126 to obtain a set of search results (e.g., including data objects 134-2, 138-1, 138-2, etc.). The graph builder 128 can process the search results (optionally subject to any configuration parameters in the configuration data 124, such as for a particular task view) to generate the global graph structure 132.

Global graph structure 132 can be an interactive graph structure presented in the global viewport 130. The interactive graph structure can include input elements associated with the data object(s) in the graph structure 132. The input elements, in response to selection, can trigger display of a local data portal 138 to facilitate interaction with the data object(s) associated with the input elements. For instance, an input element associated with the data object group 136-3 can trigger display of data objects 138-1 and 138-2.

The local data portal 138 can include one or more interactive fields for displaying and editing data associated with the data object(s) displayed in the local data portal 138. The local data portal 138 can render data objects (or previews thereof). For instance, for data objects corresponding to imaged documents, the local data portal 138 can render previews of documents. The previews can be selectable to trigger loading of the full document.

The local data portal 138 can facilitate bulk updates across one or more data objects. For instance, a given data element or field associated with a particular data object can be stored in association with other data objects in the set of related objects (e.g., objects in the graph structure 132). The local data portal 138 can provide an input element that triggers the global data manager 120 to propagate the edit in bulk to the other instances of that given data element. The global data manager 120 can propagate the edit by generating instructions to push the edit to each associated local data manager.

The local data portal 138 can facilitate monitoring and updating of status flags associated with data elements. Status flags (and other parameters) can be used to filter data retrieved for the graph structure 132.

The local data portal 138 can include a multi-column, multi-row interface. The number and type of columns/rows can be configurable. The configuration can be stored in the configuration data 124. The configurations can be used for all users or a subset of one or more users. The configuration can be associated with a user account and user preferences such that when state data 122 indicates a particular user, that user's preferences can be used.

The local data portal 138 can facilitate upload of data and documents. For instance, documents can be processed with optical character recognition (OCR) and data from the documents can be populated into corresponding data elements.

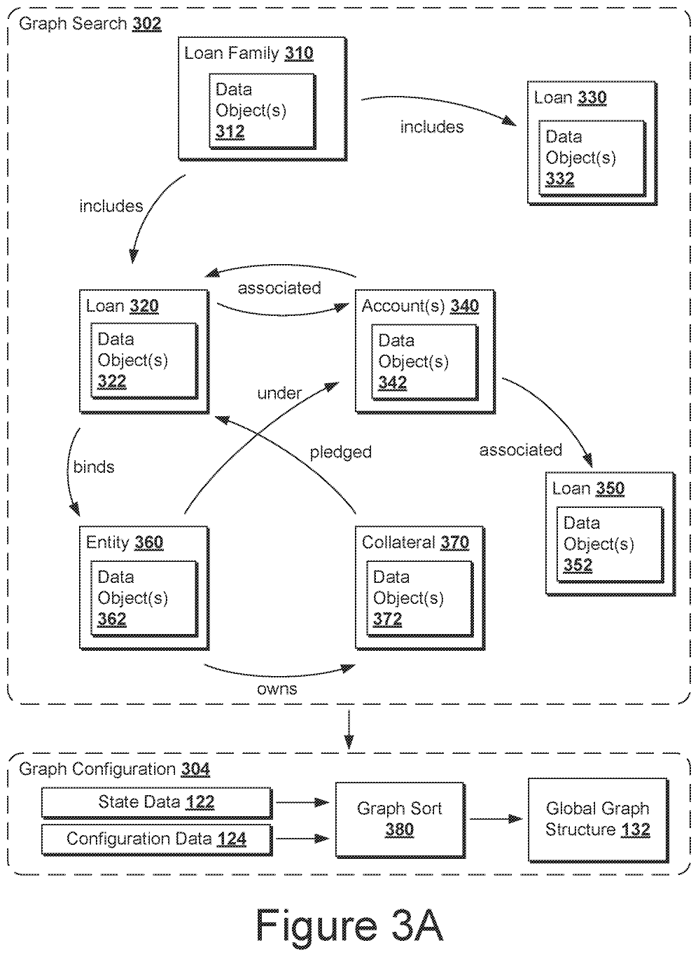

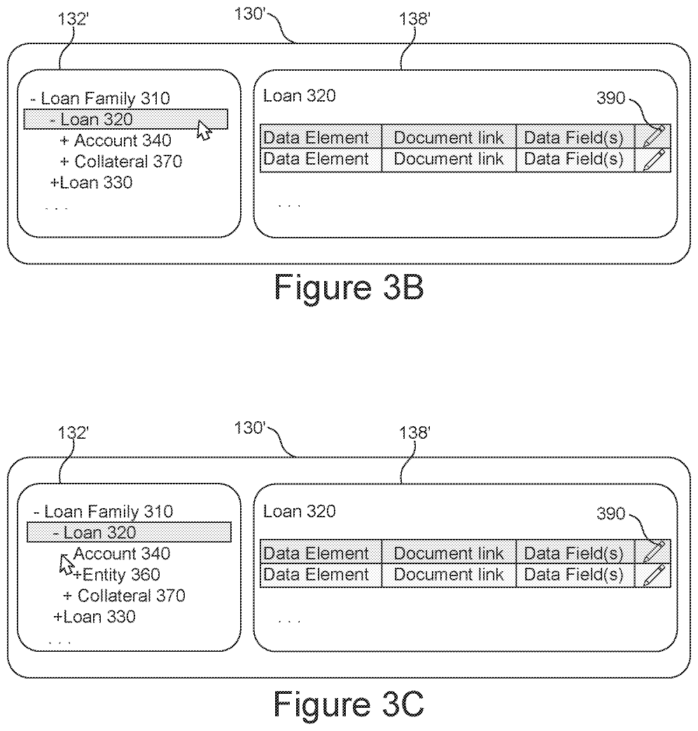

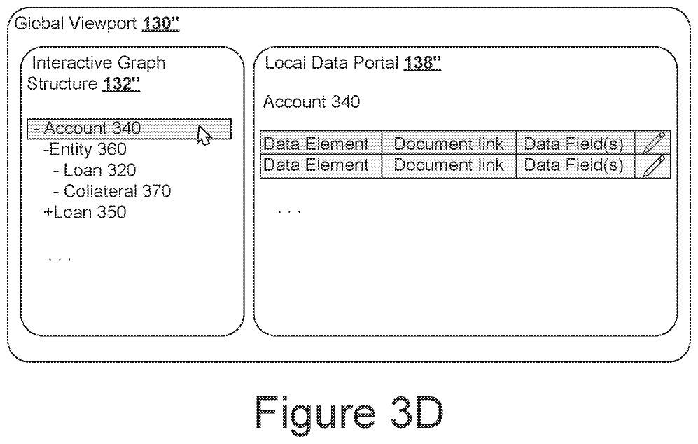

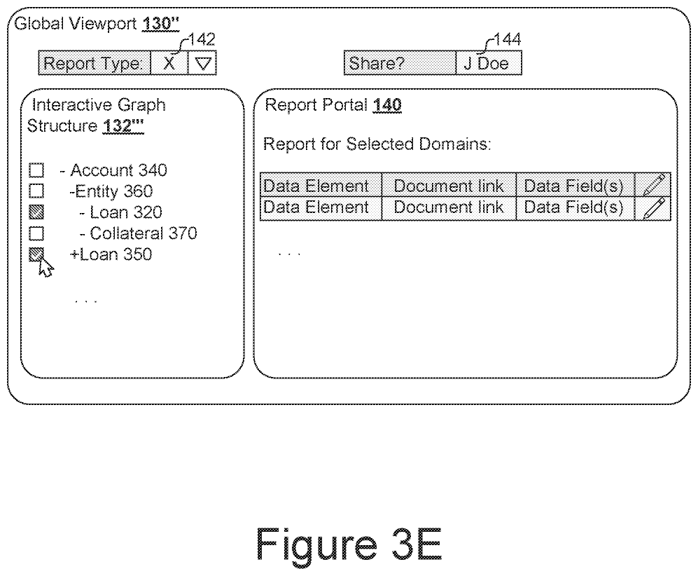

FIG. 3A is a block diagram illustrating an example implementation of using graph builder 128 to construct global graph structure 132 for an example query over loan data. Graph builder 128 can perform graph search 302 across a plurality of data managers. For instance, the search could begin based on a request indicating a loan 320 associated with data object(s) 322. The global data manager 120 can query a local data manager associated with loan listings for related loans and retrieve a loan family 310 associated with the loan 320. The loan family 310 could be associated with data objects 312. The loan family 310 could include multiple loans, including loan 320. For instance, the global data manager 120 could query the loan-related local data manager for all loans in the family 310. The results could include loan 330, associated with data object(s) 332.

Loan 320 can point to an account 340. For instance, data object(s) 322 can indicate or identify account 340. Thus the global data manager 120 can query a local data manager associated with account data and retrieve account(s) 340, associated with data object(s) 342. Account(s) 340 can also point to another loan 350, associated with data object(s) 352. Account(s) 340 can also point to an entity 360, associated with data object(s) 362, that is bound under the loan 320 and is a member of or party to the account(s) 340.

Loan 320 can also point to collateral 370 that is pledged to secure the loan 320. Thus the global data manager 120 can query a local data manager associated with collateral records to retrieve collateral 370, associated with data object(s) 372.

The graph search 302 can also include mapping the relationships between nodes of the graph. For instance, the loan family 310 can map to the two loans included in the package, loan 320 and loan 330. Loan 320 can map to the account(s) 340 associated therewith, the entity 360 bound under the loan 320, and the collateral 370 pledged under the loan 320. The account(s) 340 can map to another loan 350 associated therewith.

Graph configuration 304 can configure the graph based on the graph search 302. Graph configuration 304 can configure the graph based on the graph search 302 and configuration data 124 using a graph sort operator 380 to arrange the results of the graph search 302 into the graph structure 132. For instance, state data 122 can indicate a context associated with a task view schema of configuration data 124. The schema can indicate a sorting order or other ranking for the graph structure 132.

For instance, as an example, for a loan origination-based task view, the schema can indicate a structure with the loan family 310 as the root, with the initial viewport state corresponding to the particular loan associated with the request (e.g., loan 320). FIG. 3B illustrates: global viewport 130′ can contain two task panels or containers. A global graph structure panel 132′ can contain a hierarchical structure (e.g., tree structure) of the data objects retrieved in the graph search. The initial state can correspond to selection of loan 320 for display in the local data portal 138′. The local data portal 138′ can display data elements, fields, and links associated with the loan 320. The local data portal 138′ can include an edit feature 390 that is selectable to initiating editing of any one of the data elements, fields, and links associated with the loan 320. Although depicted as a separate icon in FIG. 3B, it is to be understood that that the various data elements, fields, and links associated with the loan 320 can also be edited by various means of initiating editing functionality, such as by a right-click, double click, etc.

As shown in FIG. 3C, the tree structure in graph structure 132′ can be collapsible.

For a client-relationship-based task view, the schema can indicate a structure with account(s) 340 as the root, etc. FIG. 3D illustrates a different ordering for global graph structure 132″ in global viewport 130″. For instance, the account 340 can be positioned as the root. The initial view can correspond to selection of account 340 for display in the local data portal 138″.

FIG. 3E illustrates an example report-building interface leveraging the interactive graph structure (e.g., graph structure 132′″). For instance, the report-building interface can use a graph search 302 for obtaining a set of data objects from which a report can be generated. A report portal 140 can present a report compiled based on the report type input 142. A report can include local data associated with each of the elements of the graph structure 132′″. A report can include local data associated with only the selected elements of the graph structure 132′″ (e.g., selected using a selectable interface element associated with the elements of the graph structure, such as a checkbox or radio button). For instance, the computing system can aggregate the local data for each of the selected elements and present the aggregated data in the report.

Report type input 142 can drive the types of records pulled for the report. For instance, in lieu of aggregating all local data for each selected element, different report types can correspond to different filters. For instance, a first report type can be associated with a feature X, such that all records containing or otherwise associated with the feature X are retrieved from the records associated with the selected elements of the interactive graph structure. For instance, a second report type can be associated with a feature Y, such that all data objects containing or otherwise associated with the feature Y are retrieved from the data objects associated with the selected elements of the interactive graph structure.

The features can indicate a status of the associated data object. The status can be, for instance, an exception status that excepts the associated data object from a typical process flow (e.g., adherence to a default compliance date, etc.). Accordingly, it may be desired to obtain a report for all data objects assigned an exception status within the set of data objects retrieved as a result of the graph search. Such an exception status may be determined by reference to a data field associated with the data object indicating the exception status (e.g., a flag or other value indicating classification as an exception).

Different report types can be associated with one or more auxiliary data tables. The auxiliary data tables can contain a mapping of data associated with that report type. For instance, for an “awaiting review” report type, an auxiliary table can include a list of reviewers. The list of reviewers can be further organized by entity, data object type, etc.

When displaying the report, the computing system can inject auxiliary data from the auxiliary data tables into the data fields for the data object. For instance, the computing system can inject a reviewer name into a data field associated with a data object that the reviewer is assigned to review. This data may be stored in different data tables but, in real time as the report is generated, be aggregated for presentation in the report portal 140 of the global viewport 130″.

A share input feature 144 can trigger sharing of the produced report. For instance, the items of the produced report can have an exception status, awaiting review status, or other status indicating an action needed to be performed by another party. Share input feature 144 can provide a selectable user interface element for initiating sharing of the report generated in the report portal 140.

The share input feature 144 can permit sharing of the entire report with an entity. The share input feature 144 can permit sharing of the respective data objects with entities respectively associated with the respective data objects.

Upon sharing of the report, the entity with which the report is shared can receive authorization to access the report via a portal to which the entity has access. For instance, global viewport 130″ can be provided in an internal dashboard interface. An external dashboard interface can contain a portal for viewing or otherwise interacting with generated reports. The external dashboard might only have permissions to view reports shared with a user account associated with the external dashboard. The external dashboard can facilitate processing of shared data objects. For instance, for a report containing a listing of all data objects awaiting review, sharing the report with the reviewing entity can enable the reviewing entity to efficiently review the data objects in the report via the external dashboard interface. As the report is updated, the external dashboard can also be updated to reflect a current state of the shared report. Further, the external dashboard can provide an interactive interface for inputting data or uploading documents associated with data objects on the shared report. The external dashboard can provide an interactive interface for indicating completion of tasks associated with data objects on the shared report.

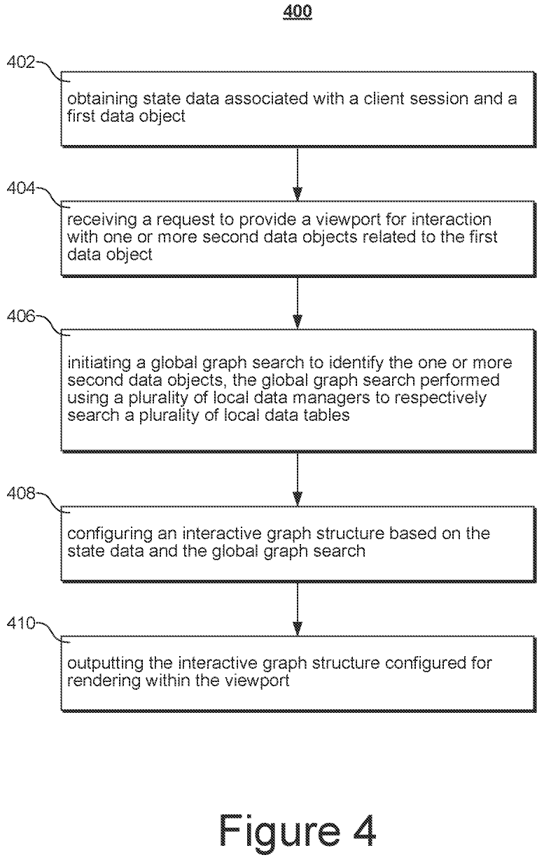

FIG. 4 depicts a flowchart of a method 400 for implementing a global data management framework according to aspects of the present disclosure. One or more portion(s) of the method 400 can be implemented by a computing system that includes one or more computing devices such as, for example, the computing systems described with reference to the other figures (e.g., as in FIGS. 1, 2, 3, 5, etc.). Each respective portion of the method 400 can be performed by any (or any combination) of one or more computing devices. Moreover, one or more portion(s) of the method 400 can be implemented on the hardware components of the device(s) described herein (e.g., as in FIGS. 1, 2, 3, 5, etc.). FIG. 4 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 4 is described with reference to elements/terms described with respect to other systems and figures for exemplary illustrated purposes and is not meant to be limiting. One or more portions of method 400 can be performed additionally, or alternatively, by other systems.

At 402, the method 400 can include obtaining state data associated with a client session and a first data object. For instance, state data can be obtained that indicates one or more data objects or topics associated with a current or past activity of the client session.

In some implementations, the state data can be associated with a task view (e.g., as specified in configuration data 124). In some implementations, the state data can indicate a user account. In some implementations, the viewport can be configured based on user configuration data associated with the user account. In some implementations, the state data can indicate temporary configuration parameters persisted in a temporary cache on a client computing device.

At 404, the method 400 can include receiving a request to provide a viewport for interaction with one or more second data objects related to the first data object. For instance, a viewport (e.g., viewport 130) can be rendered within a graphical user interface (e.g., on a display device of a client computing system). The viewport can include a single pane or container that presents a unified interface for browsing and editing data. For instance, the viewport can be rendered by a web browser (e.g., as a web page, as a pop-up overlay over a web page, etc.).

In some implementations, the request can be based on an input signal received at a client computing device. In some implementations, the request can be triggered by execution of a hyperlink at a client computing device. In some implementations, the request can be triggered by a refresh command executed at a client computing device.

At 406, the method 400 can include initiating a global graph search to identify the one or more second data objects. In some implementations, the global graph search can be performed using a plurality of local data managers (e.g., data managers 104-1, 104-2, . . . , 104-n, 114-1, etc.) to respectively search a plurality of local data tables (e.g., data tables 102-1, 102-2, . . . , 102-n, 112-1, etc.). In some implementations, at least one of the one or more second data objects can be at least one of: a document, a data record, or a placeholder.

In some implementations, the plurality of local data managers can share at least a portion of a data store. In some implementations, a first local data manager of the plurality of local data managers can manage a first data table in a first data store, and a second local data manager of the plurality of local data managers can manage a second data table in a second data store. In some implementations, the first data store can be hosted by a first entity and the second data store can be hosted by a second entity.

In some implementations, the global graph search can be a depth-first search. In some implementations, the global graph search can be a breadth-first search across the plurality of local data managers and a depth-first search within each local data manager.

In some implementations, the global graph search can be dynamically performed responsive to receiving the request.

In some implementations, the global graph search can be performed by, for a respective local data manager of the plurality of local data managers, obtaining a respective query for the respective local data manager based on an aspect of the first data object, and obtaining, from the respective local data manager and responsive to the respective query, respective query results.

In some implementations, a subsequent respective query for a subsequent respective local data manager can be based on prior respective query results.

At 408, the method 400 can include configuring an interactive graph structure (e.g., graph structure 132) based on the state data and the global graph search. In some implementations, results of the global graph search can form a knowledge graph associated with the first data object. In some implementations, the interactive graph structure can implicitly encode semantic relationships between the one or more second data objects and the first data object. For instance, in some implementations, the interactive graph structure can be rendered within the viewport in a tree structure.

In some implementations, the interactive graph structure can visually represent one or more relationships between the first data object and the one or more second data objects. In some implementations, the interactive graph structure can be configured by sorting the one or more second data objects according to a schema associated with the task view. In some implementations, the schema can indicate a data object type for the root of the interactive graph structure. In some implementations, the schema can indicate an initial position for interaction within the interactive graph structure. In some implementations, the initial position can correspond to an initial state of the viewport.

At 410, the method 400 can include outputting the interactive graph structure configured for rendering within the viewport. In the example method 400, the interactive graph structure can be configured to facilitate interaction with the one or more second data objects within the viewport.

In some implementations, the interactive graph structure can be configured with selectable input elements that trigger display of at least one of the one or more second data objects within the viewport.

In some implementations, the viewport can be configured to facilitate editing, within the viewport, of at least one of the one or more second data objects.

In some implementations, the example method 400 can include receiving, from the viewport, an edit to at least one of the one or more second data objects and instructing the respective local data manager corresponding to the at least one of the one or more second data objects to update the at least one of the one or more second data objects in the corresponding data table.

In some implementations of the example method 400, the example method 400 can include relaying at least one data object from a first local data manager to a second local data manager, initiating a functionality of the second local data manager that is absent from the first local data manager, and relaying the at least one data object from the second local data manager to the first local data manager.

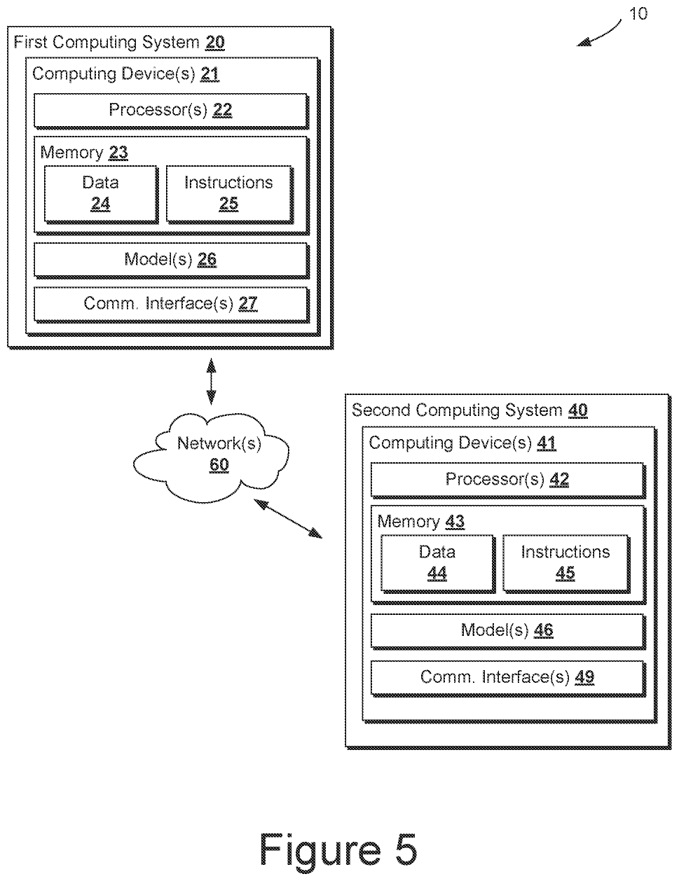

FIG. 5 is a block diagram of an example computing ecosystem 10 according to example implementations of the present disclosure. The example computing ecosystem 10 can include a first computing system 20 and a second computing system 40 that are communicatively coupled over one or more networks 60. In some implementations, the first computing system 20 or the second computing 40 can implement one or more of the systems, operations, or functionalities described herein (e.g., global data management framework 100, one or more portions thereof, such as global data manager 120, global viewport 130, etc.).

In some implementations, the first computing system 20 can be included in a client computing system, terminal computing system, endpoint/edge computing system, etc. In other implementations, the first computing system 20 may not be included in a client computing system. The first computing system 20 can include one or more distinct physical computing devices 21, such as a server and a thin client, etc.

The first computing system 20 (e.g., the computing device(s) 21 thereof) can include one or more processors 22 and a memory 23. The one or more processors 22 can be any suitable processing device (e.g., a processor core, a microprocessor, an ASIC, a FPGA, a controller, a microcontroller, etc.) and can be one processor or a plurality of processors that are operatively connected. The memory 23 can include one or more non-transitory computer-readable storage media, such as RAM, ROM, EEPROM, EPROM, one or more memory devices, flash memory devices, etc., and combinations thereof.

The memory 23 can store information that can be accessed by the one or more processors 22. For instance, the memory 23 (e.g., one or more non-transitory computer-readable storage media, memory devices, etc.) can store data 24 that can be obtained (e.g., received, accessed, written, manipulated, created, generated, stored, pulled, downloaded, etc.). The data 24 can include, for instance, data objects, data records, documents (e.g., imaged documents, transcribed documents, etc.), or any data or information described herein. In some implementations, the first computing system 20 can obtain data from one or more memory device(s) that are remote from the first computing system 20, such as one or more cloud storage services.

The memory 23 can store computer-readable instructions 25 that can be executed by the one or more processors 22. The instructions 25 can be software written in any suitable programming language or can be implemented in hardware. Additionally, or alternatively, the instructions 25 can be executed in logically or virtually separate threads on the processor(s) 22.

For example, the memory 23 can store instructions 25 that are executable by one or more processors (e.g., by the one or more processors 22, by one or more other processors, etc.) to perform (e.g., with the computing device(s) 21, the first computing system 20, or other system(s) having processors executing the instructions) any of the operations, functions, or methods/processes (or portions thereof) described herein.

In some implementations, the first computing system 20 can store or include one or more models 26. In some implementations, the models 26 can be or can otherwise include one or more machine-learned models (e.g., a machine-learned operational system, etc.). As examples, the models 26 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

In some implementations, the models 26 can include data models, such as one or more protocols or schemas for structuring interactions with and updates to a database, data table, or other data storage mechanism.

In some implementations, the first computing system 20 can obtain the one or more models 26 using communication interface(s) 27 to communicate with the second computing system 40 over the network(s) 60. For instance, the first computing system 20 can store the model(s) 26 (e.g., one or more machine-learned models) in the memory 23. The first computing system 20 can then use or otherwise implement the models 26 (e.g., by the processors 22).

The second computing system 40 can include one or more computing devices 41. The second computing system 40 can include one or more processors 42 and a memory 43. The one or more processors 42 can be any suitable processing device (e.g., a processor core, a microprocessor, an ASIC, a FPGA, a controller, a microcontroller, etc.) and can be one processor or a plurality of processors that are operatively connected. The memory 43 can include one or more non-transitory computer-readable storage media, such as RAM, ROM, EEPROM, EPROM, one or more memory devices, flash memory devices, etc., and combinations thereof.

The memory 43 can store information that can be accessed by the one or more processors 42. For instance, the memory 43 (e.g., one or more non-transitory computer-readable storage media, memory devices, etc.) can store data 44 that can be obtained. The data 44 can include, for instance, data objects, data records, documents (e.g., imaged documents, transcribed documents, etc.), or any data or information described herein. In some implementations, the second computing system 40 can obtain data from one or more memory device(s) that are remote from the second computing system 40.

The memory 43 can also store computer-readable instructions 45 that can be executed by the one or more processors 42. The instructions 45 can be software written in any suitable programming language or can be implemented in hardware. Additionally, or alternatively, the instructions 45 can be executed in logically or virtually separate threads on the processor(s) 42.

For example, the memory 43 can store instructions 45 that are executable (e.g., by the one or more processors 42, by the one or more processors 22, by one or more other processors, etc.) to perform (e.g., with the computing device(s) 41, the second computing system 40, or other system(s) having processors for executing the instructions, such as computing device(s) 21 or the first computing system 20) any of the operations, functions, or methods/processes described herein.

In some implementations, the second computing system 40 can include one or more server computing devices. In the event that the second computing system 40 includes multiple server computing devices, such server computing devices can operate according to various computing architectures, including, for example, sequential computing architectures, parallel computing architectures, or some combination thereof.

Additionally, or alternatively to, the model(s) 26 at the first computing system 20, the second computing system 40 can include one or more models 46. As examples, the model(s) 46 can be or can otherwise include various machine-learned models (e.g., a machine-learned operational system, etc.) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

In some implementations, the models 46 can include data models, such as one or more protocols or schemas for structuring interactions with and updates to a database, data table, or other data storage mechanism.

In some implementations, the second computing system 40 or the first computing system 20 can train one or more machine-learned models of the model(s) 26 or the model(s) 46 through the use of one or more model trainers 47 and training data 48. The model trainer(s) 47 can train any one of the model(s) 26 or the model(s) 46 using one or more training or learning algorithms. One example training technique is backwards propagation of errors. In some implementations, the model trainer(s) 47 can perform supervised training techniques using labeled training data. In other implementations, the model trainer(s) 47 can perform unsupervised training techniques using unlabeled training data. In some implementations, the second computing system 40 can implement simulations for obtaining the training data 48 or for implementing the model trainer(s) 47 for training or testing the model(s) 26 or the model(s) 46. In some implementations, the model trainer(s) 47 can perform a number of generalization techniques to improve the generalization capability of the model(s) being trained. Generalization techniques include weight decays, dropouts, or other techniques.

For example, in some implementations, the second computing system 40 can generate training data 48 according to example aspects of the present disclosure. For instance, the second computing system 40 can generate training data 48. For instance, the second computing system 40 can implement methods according to example aspects of the present disclosure. The second computing system 40 can use the training data 48 to train model(s) 26. In this manner, for instance, the second computing system 40 can provide a training pipeline for training model(s) 26.

The first computing system 20 and the second computing system 40 can each include communication interfaces 27 and 49, respectively. The communication interfaces 27, 49 can be used to communicate with each other or one or more other systems or devices, including systems or devices that are remotely located from the first computing system 20 or the second computing system 40. The communication interfaces 27, 49 can include any circuits, components, software, etc. for communicating with one or more networks (e.g., the network(s) 60). In some implementations, the communication interfaces 27, 49 can include, for example, one or more of a communications controller, receiver, transceiver, transmitter, port, conductors, software or hardware for communicating data.

The network(s) 60 can be any type of network or combination of networks that allows for communication between devices. In some implementations, the network(s) can include one or more of a local area network, wide area network, the Internet, secure network, cellular network, mesh network, peer-to-peer communication link or some combination thereof and can include any number of wired or wireless links. Communication over the network(s) 60 can be accomplished, for instance, through a network interface using any type of protocol, protection scheme, encoding, format, packaging, etc.

FIG. 5 illustrates one example computing ecosystem 10 that can be used to implement the present disclosure. Other systems can be used as well. For example, in some implementations, the first computing system 20 can include the model trainer(s) 47 and the training data 48. In such implementations, the model(s) 26, 46 can be both trained and used locally at the first computing system 20. As another example, in some implementations, the computing system 20 may not be connected to other computing systems. Additionally, components illustrated or discussed as being included in one of the computing systems 20 or 40 can instead be included in another one of the computing systems 20 or 40.

In an example configuration, first computing system 20 can correspond to a first party database system (e.g., operating or otherwise associated with framework 100) and second computing system 40 can correspond to a third party database system. A first party database system can use storage available on the third party database system to store information. For instance, an example storage schema can include storing metadata in association with document files (e.g., scanned images of physical documents, digital instances of documents, etc.). An example first party database can store the metadata and the third party database can store the document file(s). The example first party database can store, along with the metadata, a resource locator that points to the storage location on the third party database.

First computing system 20 can provide a data import interface that facilitates import of new data (e.g., new documents). First computing system 20 can host a software application that is configured to display one or more input fields for receiving user inputs. The input fields can be configured for receiving metadata entry, links to local or externally hosted documents, etc. The software application can be configured to upload the linked document(s) to a storage location (e.g., on first computing system 20 or on an external storage system, such as on second computing system 40).

First computing system 20 can be configured to perform one or more preprocessing operations on imported documents. An example preprocessing operation can include performing optical character recognition to identify textual or other symbolic content in the document. For files already stored with symbolic data in a computer-readable format (e.g., documents generated by a word processing application), optical character recognition might not be used.

An example preprocessing operation can include parsing document contents. The document contents can be parsed to populate one or more metadata fields associated with the document file. The contents can be parsed using, for instance, a machine-learned model. The machine-learned model can be, for instance, a natural language processing model, an image processing model, multimodal models, etc. The document contents can be stored in one or more metadata fields associated with the document file. The document contents can be categorized, classified, or otherwise used to determine attributes of the document (e.g., document type, document category, document status, etc.). Entity extraction can be performed on the document to populate entity fields in the metadata (e.g., dates, names, values, etc.).

An example preprocessing operation can include detecting annotations to the document. For example, a user can mark up a document using document annotation software. The document annotation software can operate on or be executed by first computing system 20. The document annotation software can operate on a different computing system. The user can import an annotated document (e.g., as described above).

First computing system 20 can process the annotated document to detect the annotations. Annotations can be detected using, for example, one or more machine-learned models (e.g., natural language processing models, image processing models, etc.). First computing system 20 can store metadata that indicates the presence of the detected annotations. First computing system 20 can parse the annotated document to extract content from the annotations. First computing system 20 can parse the annotations to populate one or more metadata fields.

In an example, an annotation in an annotated document can indicate a portion of the document for review, correction, completion, revision, etc. First computing system 20 can detect and parse the annotation to populate a metadata field that indicates, for the imported document, a status of the document associated with, for example, the review, correction, completion, revision, etc.

An annotated document can be shared with another system or entity to facilitate execution of requested actions indicated in the annotations. Upon sharing of the annotated document, the entity with which the annotated document is shared can receive authorization to access the annotated document via a portal to which the entity has access. For instance, an external dashboard interface can contain a portal for viewing or otherwise interacting with annotated documents. The external dashboard might only have permissions to view annotated documents shared with a user account associated with the external dashboard. The external dashboard can facilitate processing of shared data objects. For instance, for an annotated document awaiting review, sharing the annotated document with the reviewing entity can enable the reviewing entity to efficiently review the annotated document via the external dashboard interface. As the annotated document is updated (e.g., with further annotations) or replaced (e.g., with a new revision responsive to the annotations), the external dashboard can also facilitate import of the updates or replacement document(s). In this manner, for instance, the dashboard can reflect a current state of the annotated document. Further, the external dashboard can provide an interactive interface for inputting data or uploading documents associated with the annotated document. The external dashboard can provide an interactive interface for indicating completion of tasks associated with the annotated document.

Computing tasks discussed herein as being performed at computing device(s) remotely can instead be performed locally, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A computer-implemented method comprising:
obtaining state data associated with a client session and a first data object;
receiving a request to provide a viewport for interaction with one or more second data objects related to the first data object;
initiating a global graph search to identify the one or more second data objects, the global graph search performed using a plurality of local data managers to respectively search a plurality of local data tables;
configuring an interactive graph structure based on the state data and the global graph search; and
outputting the interactive graph structure configured for rendering within the viewport;
wherein the interactive graph structure is configured to facilitate interaction with the one or more second data objects within the viewport.

2. The method of claim 1, comprising:
relaying at least one data object from a first local data manager to a second local data manager;
initiating a functionality of the second local data manager that is absent from the first local data manager; and
relaying the at least one data object from the second local data manager to the first local data manager.

3. The method of claim 1, wherein at least one of the one or more second data objects is at least one of: a document, a data record, or a placeholder.

4. The method of claim 1, wherein the state data indicates at least one of:
a task view, and wherein the interactive graph structure is configured by sorting the one or more second data objects according to a schema associated with the task view;
a user account, and wherein the viewport is configured based on user configuration data associated with the user account; or
temporary configuration parameters persisted in a temporary cache on a client computing device.

5. The method of claim 4, wherein the schema indicates at least one of:
a data object type for a root of the interactive graph structure; or
an initial position for interaction within the interactive graph structure that corresponds to an initial state of the viewport.

6. The method of claim 1, wherein the interactive graph structure is configured with selectable input elements that trigger display of at least one of the one or more second data objects within the viewport.

7. The method of claim 1, wherein the interactive graph structure is rendered within the viewport in a tree structure that visually represents one or more relationships between the first data object and the one or more second data objects.

8. The method of claim 1, comprising:
receiving, from the viewport, an edit to at least one of the one or more second data objects; and
instructing the respective local data manager corresponding to the at least one of the one or more second data objects to update the at least one of the one or more second data objects in the corresponding data table.

9. The method of claim 1, wherein the global graph search is dynamically performed responsive to receiving the request.

10. The method of claim 1, wherein the global graph search is performed by:
for a respective local data manager of the plurality of local data managers:
obtaining a respective query for the respective local data manager based on an aspect of the first data object; and
obtaining, from the respective local data manager and responsive to the respective query, respective query results.

11. The method of claim 1, wherein a subsequent respective query for a subsequent respective local data manager is based on prior respective query results.

12. The method of claim 1, wherein the global graph search is a depth-first search.

13. The method of claim 1, wherein the global graph search is a breadth-first search across the plurality of local data managers and a depth-first search within each local data manager.

14. The method of claim 1, wherein the plurality of local data managers share at least a portion of a data store.

15. The method of claim 1, wherein:
a first local data manager of the plurality of local data managers manages a first data table in a first data store; and
a second local data manager of the plurality of local data managers manages a second data table in a second data store.

16. The method of claim 1, wherein the first data store is hosted by a first entity and the second data store is hosted by a second entity.

17. The method of claim 1, wherein results of the global graph search form a knowledge graph associated with the first data object.

18. The method of claim 1, wherein the interactive graph structure implicitly encodes semantic relationships between the one or more second data objects and the first data object.

19. One or more non-transitory computer-readable media storing instructions executable to cause one or more processors to perform operations, the operations comprising:
obtaining state data associated with a client session and a first data object;
receiving a request to provide a viewport for interaction with one or more second data objects related to the first data object;
initiating a global graph search to identify the one or more second data objects, the global graph search performed using a plurality of local data managers to respectively search a plurality of local data tables;
configuring an interactive graph structure based on the state data and the global graph search; and
outputting the interactive graph structure configured for rendering within the viewport;
wherein the interactive graph structure is configured to facilitate interaction with the one or more second data objects within the viewport.

20. A computing system comprising:
one or more processors; and
one or more non-transitory computer-readable media storing instructions executable to cause the one or more processors to perform operations, the operations comprising:
obtaining state data associated with a client session and a first data object;
receiving a request to provide a viewport for interaction with one or more second data objects related to the first data object;
initiating a global graph search to identify the one or more second data objects, the global graph search performed using a plurality of local data managers to respectively search a plurality of local data tables;
configuring an interactive graph structure based on the state data and the global graph search; and
outputting the interactive graph structure configured for rendering within the viewport;
wherein the interactive graph structure is configured to facilitate interaction with the one or more second data objects within the viewport.
